(19) United States
(12) Patent Application Publication
(10) Pub. No.: US 2024/0375714 A1
(43) Pub. Date: Nov. 14, 2024

(54) METHOD, COMPUTER PROGRAMME PRODUCT, PARKING ASSISTANCE SYSTEM, AND VEHICLE

(71) Applicant: VALEO SCHALTER UND SENSOREN GMBH, Bietigheim-Bissingen (DE)

(72) Inventors: Lasse Schnepel, Bietigheim-Bissingen (DE); Frederic Gehin, Bietigheim-Bissingen (DE); Markus Heimberger, Bietigheim-Bissingen (DE); Fabian Fuchs, Bietigheim-Bissingen (DE)

(73) Assignee: VALEO SCHALTER UND SENSOREN GMBH, Bietigheim-Bissingen (DE)

(21) Appl. No.: 18/693,698

(22) PCT Filed: Sep. 22, 2022
(86) PCT No.: PCT/EP2022/076312

§ 371 Date: Mar. 20, 2024

(30) Foreign Application Priority Data
Sep. 23, 2021 (DE) 10 2021 124 662.8

(51) Int. Cl. B62D 15/02; G06V 20/58

(52) U.S. Cl. CPC B62D 15/0285; G06V 20/58

(57) ABSTRACT

A method for operating a parking assistance system for a vehicle is disclosed. The parking assistance system is configured to learn a manually traveled trajectory in a learning mode, and to automatically retrace the learned trajectory with the vehicle in a retracing mode. The learning mode includes receiving an inclination angle sensor signal from a sensor unit of the vehicle, ascertaining a curb at a specific position along the trajectory depending on the received inclination angle sensor signal. The retracing mode includes receiving an environmental sensor signal from an environment sensor unit of the vehicle, ascertaining the position of the obstacle on the learned trajectory depending on the received environmental sensor signal, and performing the retracing according to a first or second rule set depending on a comparison of the ascertained position and the position determined in the learning mode.

The present invention relates to a method for operating a parking assistance system, a computer program product, a parking assistance system and a vehicle.

Parking assistance systems which support what is known as “trained parking” are known. Here, in a training or learning mode, a specific route is traveled manually with the vehicle and recorded by the parking assistance system. During this journey, the environment is detected by sensors of the vehicle and stored correspondingly by the parking assistance system. On the basis of the stored information, the parking assistance system is capable of retracing the trained or learned trajectory automatically, wherein it is oriented in particular on specific features in the environment.

During the retracing, possible obstacles in the environment are likewise detected in order to avoid a collision with an obstacle which was not yet present or was not detected during the training journey or learning journey. Depending on the equipment of the vehicle with sensors, more or less complex means are available here. In particular if the vehicle is equipped only with an ultrasonic sensor for detecting the environment, it is possible for erroneous determination of an obstacle to occur if there are specific objects. This applies in particular to objects such as a threshold or garage entry or a curbstone which the vehicle should simply travel over but which can emerge as an obstacle in an ultrasound sensor signal. In this case, retracing the learned trajectory is aborted, which is annoying for the user of the vehicle.

Against this background, an object of the present invention is to improve the operation of a parking assistance system.

According to a first aspect, a method for operating a parking assistance system for a vehicle is proposed. The parking assistance system is configured to learn a manually traveled trajectory in a learning mode, and to retrace the learned trajectory automatically with the vehicle in a retracing mode. The learning mode comprises:
receiving an inclination angle sensor signal from a sensor unit of the vehicle, which signal is indicative of an inclination angle of the vehicle or a roadway and/or a change in the inclination angle of the vehicle or the roadway, during the manual travel along the trajectory, and
ascertaining a curb at a specific position of the trajectory depending on the received inclination angle sensor signal.

The retracing mode comprises:
receiving an environment sensor signal from an environment sensor unit of the vehicle, which signal is indicative of an obstacle arranged in the direction of travel of the vehicle at a position of the learned trajectory during the automatic retracing of the learned trajectory,
ascertaining the position of the obstacle on the learned trajectory depending on the received environment sensor signal, and
performing the retracing according to a first rule set or according to a second rule set depending on a comparison of the ascertained position and the position determined in the learning mode.

This method has the advantage that, on the basis of the inclination angle of the roadway or the change in the inclination angle of the roadway during the learning of the trajectory, the point of the trajectory at which false-positive detections of obstacles must be expected is ascertained. Accordingly, at the positions of the trajectory thus ascertained, the behavior of the parking assistance system can be adjusted when retracing, in order to avoid abortion of the retracing on the basis of a faulty detection of an obstacle. The faulty detection of the obstacle is understood in particular to mean that the curb which is located along the trajectory and over which the vehicle has to drive is detected as an obstacle. The method can also advantageously be used when other objects which are arranged in the vicinity of the curb increasingly lead to erroneous detections. One example of this is water discharge channels, in particular when these are covered with a grating or the like that can be driven over. In such situations, the curb is also suitable as an indicator that increased erroneous detections of obstacles must be expected.

Here is a brief example of this. For example, the trajectory runs from an entry into a garage, which is separated from the entry by a curb in the form of a threshold of about 3-5 cm height. It is therefore necessary to drive over this edge when entering the garage. During the learning of the trajectory, the user drives the vehicle over this edge into the garage. When, for example, the front wheels of the vehicle strike the curb, the inclination of the vehicle changes suddenly, which is indicated by the inclination angle sensor signal. Thus, a curb is ascertained at this position of the trajectory. During the automatic retracing of the learned trajectory, the parking assistance system thus knows the position of the trajectory at which the curb is arranged. If then an environment sensor signal is received which is indicative of an obstacle which is arranged at the position of the curb, this can with increased probability be an erroneous detection of the curb as an obstacle. In order to ensure improved operation in this situation, the second rule set specifically adjusted for such situations comes into use during the control of the vehicle. Since it is not ruled out that an obstacle is actually arranged at the position of the curb, such as for example a closed garage door, the second rule set must be defined such that actual obstacles continue to be detected reliably.

During the learning of the trajectory, for example, various sensor signals are recorded which characterize a driving condition of the vehicle, such as a speed, a position, a steering angle and the like, as unambiguously as possible. In addition, sensor signals are recorded by environment sensors of the vehicle, which enable, for example, an image of the environment of the vehicle, in particular a position of obstacles in the environment. By playing back the driving condition of the vehicle time-synchronously, i.e. by repeating it, the trained trajectory can be retraced. To retrace the predefined trajectory, it is desirable to take current environment sensor data into account. Therefore, during the retracing, the parking assistance system receives sensor signals that are indicative of the environment. The parking assistance system can, for example, receive this directly from one or more environment sensors of the vehicle and combine multiple sensor signals of different environment sensors, or else the parking assistance system receives the sensor signal already in a preprocessed state, for example in the form of a digital environment map in which detected obstacles in the environment are indicated.

The inclination angle sensor signal is received, for example, from an acceleration sensor, a suspension sensor and/or an artificial horizon. The inclination angle sensor signal is indicative of an inclination angle of the vehicle or the roadway and/or of a change in the inclination angle of the vehicle or the roadway. The inclination angle sensor signal indicates, for example, a current inclination angle of the vehicle or the change thereof in relation to a gravitational direction. The inclination angle sensor signal can also comprise the current inclination angle of the roadway or the change thereof in relation to a gravitational direction. It is possible, for example, to derive the inclination angle of the roadway from the inclination angle of the vehicle if the geometry of the vehicle is known, and vice versa. The inclination angle sensor signal can also comprise a necessary engine torque or a necessary engine output for moving the vehicle or can be derived therefrom. For example, a necessary engine torque is increased if the vehicle is traveling up an inclined roadway or a step (and conversely reduced when traveling down). Additionally or alternatively, the inclination angle sensor signal can comprise the speed of the vehicle since, with a constant engine torque or with a constant engine output, this is at least briefly increased or reduced when the vehicle travels up or down a curb.

A curb, which can also be designated as a step or a threshold, leads in particular to a sudden change in the inclination angle. Therefore, from such a sudden change it is possible to infer that the vehicle has driven over a curb. Ascertaining the curb therefore comprises in particular analyzing and/or evaluating the received inclination angle sensor signal. This can comprise recording a plurality of inclination angle sensor signals received one after another over time, and performing an analysis of a curve of the inclination angle sensor signal detected in this way. Ascertaining the curb comprises ascertaining the position of the curb. In embodiments, ascertaining the curb can be restricted to ascertaining the position. The curb ascertained in such a way and/or the position of the curb ascertained in such a way is, for example, stored jointly with the learned trajectory, so that this is known and defined when retrieving the learned trajectory.

It is possible for more than just one curb to be ascertained for a respective trajectory and for the position thereof to be stored. Furthermore, ascertaining the curb or the position thereof can be carried out during forward travel or else during reverse travel of the vehicle. Preferably, ascertaining the curb further comprises ascertaining whether this is a curb that is positive in the direction of travel (rising) or negative (falling). When the trajectory is reversed, this aspect of the curb changes accordingly and the respective curb can appropriately be taken into account. This is advantageous since a curb that falls in one direction causes fewer or no erroneous detections but if the direction of travel of the trajectory is reversed, this is a rising curb, which can increasingly cause erroneous detections.

In the retracing mode during the automatic retracing of the trajectory, the parking assistance system receives an environment sensor signal from an environment sensor unit of the vehicle. The environment sensor signal is indicative of an obstacle arranged in the direction of travel of the vehicle at a position of the trajectory. This means that an environment sensor signal which indicates an obstacle at the side of the vehicle or the trajectory is not considered in this case. The direction of travel can comprise forward travel or else reverse travel of the vehicle, and can comprise the vehicle traveling around a curve.

The parking assistance system ascertains the position of the obstacle on the trajectory depending on the received environment sensor signal, and compares the ascertained position with the specific position of the curb ascertained in the learning mode or with each specific position if, in relation to the trajectory, respective curbs have been ascertained at a plurality of specific positions. In this way, it is ascertained whether the ascertained position of the obstacle is at the position of the trajectory at which the curb is located. Accordingly, the retracing is continued according to a first rule set or according to a second rule set.

It should be noted that performing the retracing according to the first or second rule set depending on the comparison does not extend to the entire trajectory but is substantially limited to a section which is defined by the specific position of the curb and within which false-positive detections of an obstacle are expected. In the remaining regions, in which no curb was ascertained during the learning journey, the retracing is carried out in particular on the basis of the first rule set.

In embodiments, the method comprises performing the retracing according to the second rule set in a specific section of the trajectory if the ascertained position coincides with the position determined in the learning mode. The section comprises, for example, a distance of 10 cm or 20 cm or else more than 20 cm. The length of the section can depend on a geometry of the curb and a course of the trajectory relative to the curb.

The proposed method can also be used in particular for assistance systems which provide automatic rearward travel for a specific section briefly driven forward by the user with the vehicle. For example, a user drives with the vehicle into a dead end, in which turning is not possible. Then, the parking assistance system can automatically travel the trajectory covered by the user rearwards, in that, for example, it carries out exactly the steering movements of the user in the opposite order and rearwards. Such systems are restricted, for example, to the 50 m or else 100 m of the distance traveled that is located behind.

According to one embodiment of the method, this further comprises:
performing the retracing according to the first rule set if the ascertained position differs from the position determined in the learning mode, and
performing the retracing according to the second rule set if the ascertained position coincides with the position determined in the learning mode.

The first rule set corresponds in particular to a “normal” rule set which is used as standard when retracing a trajectory. According to the first rule set, on the basis of the received environment sensor signal, in particular an obstacle is detected which leads to abortion of the retracing in order to avoid a collision with the detected obstacle.

The second rule set corresponds in particular to a special rule set which is used only for the specific situation in which, in the region of a curb, an environment sensor signal indicative of an obstacle is received during the retracing. The second rule set is in particular defined in such a way that erroneous detection of an obstacle occurs with a lower frequency with, at the same time, substantially constant reliability in the detection of actual obstacles at which the vehicle has to stop.

The second rule set can differ from the first rule set in particular in how fast the vehicle is moving in the section, how many environment sensor signals are received before the vehicle travels onward, which algorithm or algorithms are used when evaluating the received environment sensor signals, and so on. Specifically in the algorithms used, those algorithms can be utilized which require a higher computing power and/or a longer computing time but output a more reliable result for this purpose.

According to one embodiment of the method, the second rule set comprises a threshold value, adjusted with respect to the first rule set, for ascertaining an obstacle depending on the environment sensor signal.

The threshold value for ascertaining an obstacle can in particular relate to a significance of the sensor signal which indicates an extent as to how unambiguous or reliable or robust the detection of the obstacle is. The threshold value is in particular increased, which means that the significance of the detection in the second rule set must be higher than in the first rule set, in order that the retracing is aborted on the basis of the received environment sensor signal.

According to a further embodiment of the method, the second rule set comprises:
suppressing an output of a signal indicative of the obstacle.

In this embodiment, the obstacle is, for example, treated as non-existent. Therefore, further functions, such as the initiation of emergency braking, are suppressed.

Preferably, the output of a signal indicative of the obstacle is suppressed depending on a significance of the detection of the obstacle.

According to a further embodiment of the method, the second rule set comprises:
outputting a false-positive signal which is indicative of the fact that the obstacle is an obstacle that can be driven over.

In the present case, an “obstacle that can be driven over” is understood to mean an obstacle which can be driven over without damage to the vehicle or to the obstacle.

According to a further embodiment of the method, this further comprises:
ascertaining a distance-inclination diagram depending on the inclination angle sensor signal received during the manual travel along the trajectory, and
ascertaining a number of sections along the trajectory within which automatic retracing is carried out according to the second rule set, depending on the ascertained distance-inclination diagram.

In this embodiment, it is preferably already determined in advance which sections of the trajectory are retraced using the second rule set. A respective section comprises, for example, a range of 10 cm, 20 cm, 30 cm or up to 50 cm of the trajectory.

According to a further embodiment of the method, this further comprises:
ascertaining a height and/or a flank angle of the curb depending on the received inclination angle sensor signal, and
adjusting at least one parameter of the second rule set depending on the ascertained height and/or the ascertained flank angle.

This embodiment makes it possible in particular to use different second rule sets for differently configured curbs that are driven over. In this embodiment, therefore, in particular not only does a second rule set exist but there can be an individual second rule set for each curb driven over along a learned trajectory.

The parameter of the second rule set which is to be adapted is, for example, the threshold value for ascertaining the obstacle depending on the environment sensor signal.

In embodiments, provision can be made for there to be a plurality of predetermined second rule sets, which each differ from one another in at least one parameter, wherein a specific rule set is selected from the plurality and is intended for use with the corresponding curb on the basis of the ascertained height and/or the ascertained flank angle.

According to a further embodiment of the method, the environment sensor signal comprises a sensor signal from an ultrasonic sensor, a laser scanner and/or a lidar.

In particular, the aforementioned sensors can be susceptible to detecting a curb erroneously as an obstacle.

According to a second aspect, a computer program product is proposed which comprises commands that, when the program is executed by a parking assistance system of a vehicle, prompt the latter to perform the method according to the first aspect.

A computer program product, such as a computer program means, may be provided or delivered, for example, as a storage medium such as a memory card, a USB stick, a CD-ROM, a DVD, or in the form of a downloadable file from a server in a network. This may take place for example in a wireless communication network by transmitting a corresponding file containing the computer program product or the computer program means.

According to a third aspect, a parking assistance system for a vehicle is proposed. The parking assistance system is configured to learn a manually traveled trajectory in a learning mode, and to retrace the learned trajectory automatically with the vehicle in a retracing mode. The parking assistance system comprises:
a receiving unit, which is configured to receive an inclination angle sensor signal from a sensor unit of the vehicle, which signal is indicative of an inclination angle of the vehicle or of a roadway and/or a change in the inclination angle of the vehicle or the roadway during the manual travel along the trajectory,
an ascertainment unit, which is configured to ascertain a curb at a specific position along the trajectory depending on the received inclination angle sensor signal, wherein
the receiving unit is also configured to receive an environment sensor signal from an environment sensor unit of the vehicle during the automatic retracing of the learned trajectory, which signal is indicative of an obstacle arranged in the direction of travel of the vehicle at a position of the learned trajectory, and
the ascertainment unit is also configured to ascertain the position of the obstacle on the learned trajectory depending on the received environment sensor signal. The parking assistance system comprises a control unit, which is configured to perform the retracing according to a first rule set or a second rule set depending on a comparison of the ascertained position with the position determined in the learning mode.

The embodiments and features described for the proposed method apply accordingly to the proposed parking assistance system.

The respective unit of the parking assistance system may be implemented in hardware and/or software. In the case of an implementation in hardware, the respective unit may be in the form of a computer or a microprocessor, for example. In the case of an implementation in software, the respective unit may be in the form of a computer program product, a function, a routine, an algorithm, part of a program code, or an executable object. Furthermore, each of the units mentioned here may also be in the form of part of a superordinate control system of the vehicle, such as a central electronic control device and/or an engine control unit (ECU: Engine Control Unit).

The parking assistance system is designed in particular for partially autonomous or fully autonomous driving of the vehicle. Semi-autonomous driving is understood to mean for example that the parking assistance system controls a steering apparatus and/or an automatic gear selection system. Fully autonomous driving is understood to mean for example that the parking assistance system additionally also controls a drive device and a braking device of the vehicle.

According to a fourth aspect, a vehicle having at least one sensor unit for detecting and outputting an inclination angle sensor signal indicative of an inclination angle of the vehicle or a roadway and/or of a change in the inclination angle of the vehicle or the roadway, and an environment sensor unit for detecting and outputting an environment sensor signal indicative of an obstacle arranged in the direction of travel of the vehicle, and having a parking assistance system according to the third aspect is proposed.

The vehicle is, for example, an automobile or even a truck. The vehicle preferably comprises a number of sensor units which are configured to detect the driving state of the vehicle and to detect an environment of the vehicle. The vehicle comprises, for example, an artificial horizon, which is configured to output the inclination angle sensor signal, and a plurality of ultrasonic sensors, which are preferably combined to form an ultrasonic sensor array, which is configured to detect and output the environment sensor signal to the parking assistance system. Furthermore, the vehicle can comprise image capture devices, such as a camera, a radar (radio detection and ranging) or else a lidar (light detection and ranging), location sensors, wheel angle sensors, and/or wheel speed sensors. The sensor units are each configured to output a sensor signal, for example to the parking assistance system or driving assistance system, which carries out the partially autonomous or fully autonomous driving on the basis of the detected sensor signals.

Further possible implementations of the invention also comprise not explicitly mentioned combinations of features or embodiments described above or below with regard to the exemplary embodiments. A person skilled in the art will in this case also add individual aspects as improvements or additions to the respective basic form of the invention.

Further advantageous configurations and aspects of the invention are the subject of the dependent claims and of the exemplary embodiments of the invention that are described below. The invention is explained in more detail below on the basis of preferred embodiments with reference to the accompanying figures.

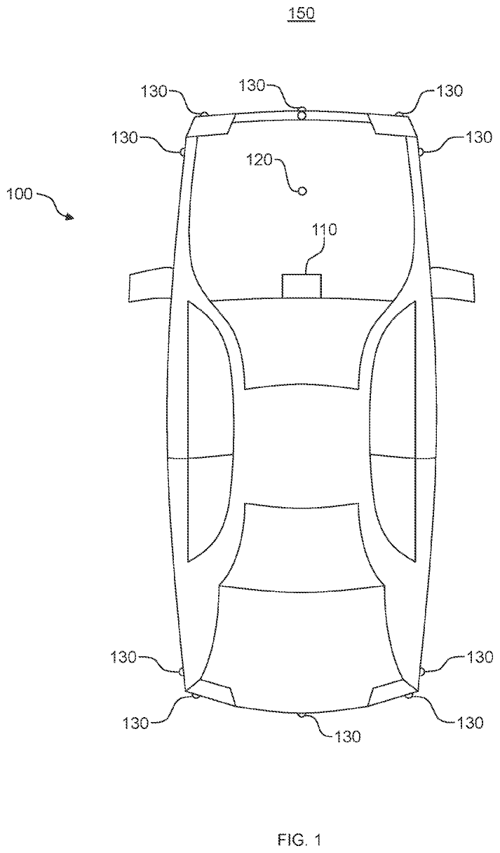

FIG. 1 shows a schematic view of a vehicle from a bird's eye perspective;

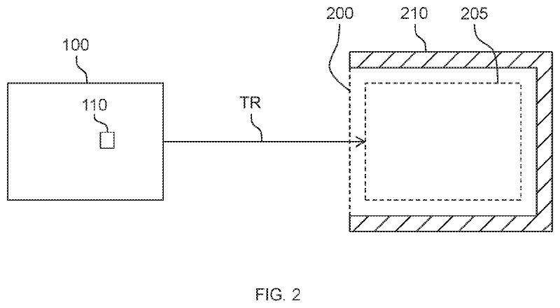

FIG. 2 shows, schematically, a trajectory which runs over a curb;

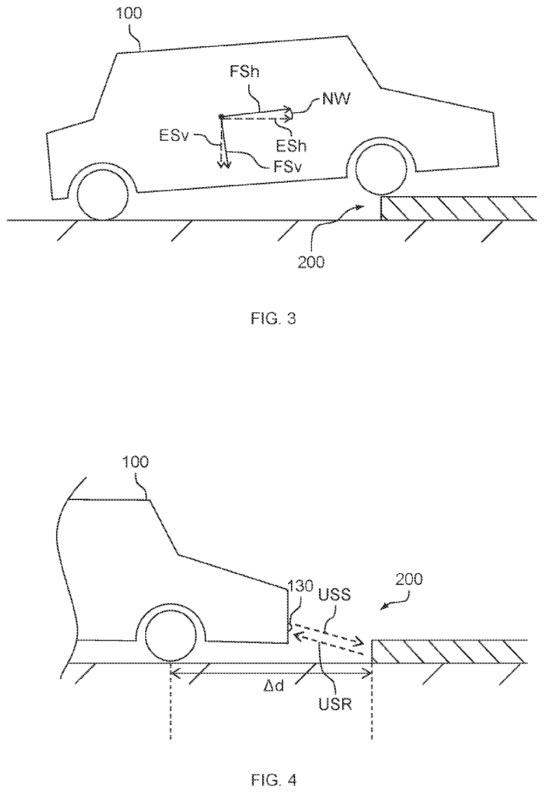

FIG. 3 shows a schematic example of ascertaining a position of a curb;

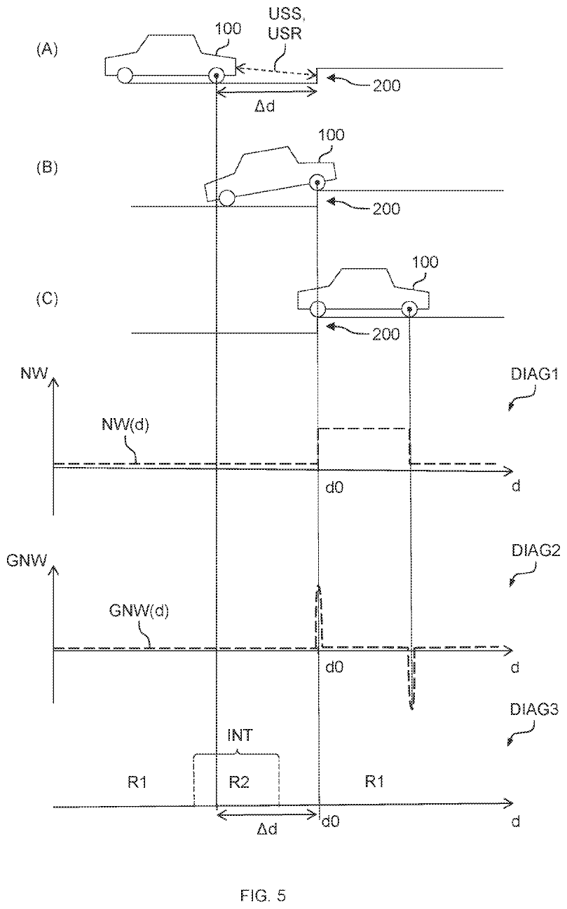

FIG. 4 shows a schematic example of detecting an environment sensor signal indicative of an obstacle;

FIG. 5 shows three exemplary diagrams;

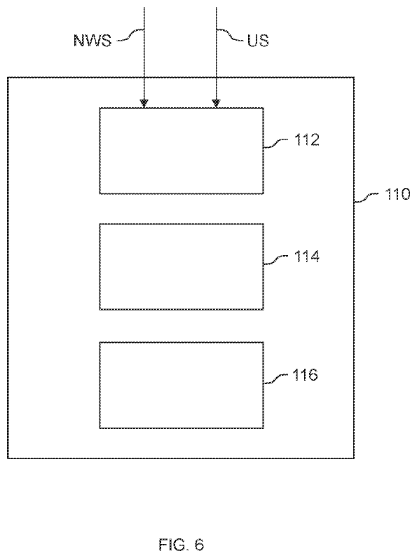

FIG. 6 shows a schematic block diagram of one exemplary embodiment of a parking assistance system; and

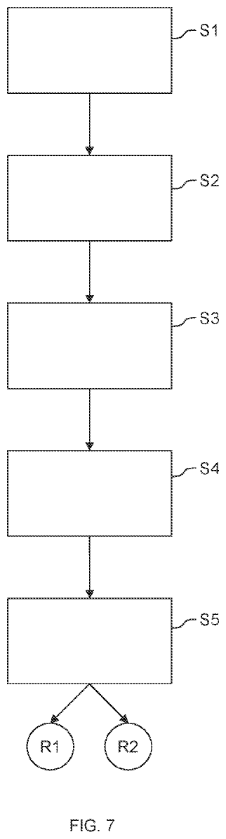

FIG. 7 shows a schematic block diagram of an exemplary embodiment of a method for operating a parking assistance system.

Identical or functionally identical elements have been provided with the same designations in the figures, unless stated otherwise.

FIG. 1 shows a schematic view of a vehicle 100 from a bird's eye perspective. The vehicle 100 is, for example, an automobile that is arranged in an environment 150. The automobile 100 has a parking assistance system 110 that is in the form of a control unit, for example. The automobile 100 comprises an inclination angle sensor 120, which is formed as an artificial horizon. In addition, a plurality of environment sensors 130 are arranged on the automobile 100, wherein these are, for example, ultrasonic sensors. The ultrasonic sensors 130 are configured to detect a distance from objects arranged in the environment 150 and to output a corresponding sensor signal. In addition to the inclination angle sensor 120 shown in FIG. 1 and the ultrasonic sensors 130, the vehicle 100 can have various further sensor devices. Examples of these are optical sensors, such as a camera, a radar and/or a lidar, an acceleration sensor, a wheel speed sensor, a steering angle sensor, an antenna with a coupled receiver for receiving electromagnetically transmittable data signals, and the like.

On the basis of the sensor signals received from the sensors 120, 130, the parking assistance system 110 is capable of performing the method described with reference to FIG. 7 and of driving the vehicle 100 partly autonomously or even fully autonomously along a trained trajectory TR (see FIG. 2). The parking assistance system 110 is, for example, designed as explained with reference to FIG. 6 and can be configured to perform the processing steps explained below with reference to FIGS. 2-5.

FIG. 2 shows, schematically, a vehicle 100 which is ready to retrace a trajectory TR which runs over a curb 200. It is, for example, the vehicle 100 from FIG. 1. The trajectory TR leads, for example, to a target position 205, which is in a garage 210. A user of the vehicle 100 has trained the trajectory TR as illustrated, so that the vehicle 100 travels autonomously into the garage 210 in the future using the parking assistance system 110. The garage 210 has a curb 200 or threshold at its entry. This is provided, for example, in order that no water runs into the garage 210 from outside.

It should be noted that the situation illustrated here is merely exemplary and the invention is not restricted thereto. Instead, it can also be another type of curb 200, such as a curbstone.

Furthermore, the curb 200 can be present only on one side of the vehicle 100, so that, for example, only one of the wheels of the vehicle 100 rolls over same, as may be the case with a manhole cover. In addition, the trajectory TR does not necessarily have to run at right angles to the curb 200, but can also cross the latter at an acute angle.

With reference to FIG. 3, the detection of the curb 200 during a learning journey with the vehicle 100 is explained below and, with reference thereto and to FIG. 4, the detection of the curb 200 as an obstacle as the trajectory TR is retraced is explained.

FIG. 3 shows a schematic example of ascertaining a position of a curb TR. In FIG. 3, the vehicle 100 is illustrated as it is just being driven with a front wheel on the curb 200. As a result of the height difference between the front wheel and the rear wheel, an inclination of the vehicle 100 results, which deviates from a level orientation. In order to illustrate this, a coordinate system having a vertical axis FSv and a horizontal axis FSh is illustrated for a reference point of the vehicle 100. The vertical axis FSv and the horizontal axis FSh are perpendicular to each other. When the vehicle 100 is standing on a level surface, the vertical axis FSv coincides with a vertical axis ESv which lies along the direction of gravity, and the horizontal axis FSh coincides with a horizontal axis ESh perpendicular to the vertical axis ESv. The inclination angle NW of the vehicle 100 can be understood, for example, as the angle between the horizontal vehicle axis FSh and the horizontal axis ESh.

The parking assistance system 110 is in the learning mode. On the basis of the received inclination angle sensor signal NWS (see FIG. 5), it ascertains that a corresponding curb 200 has been driven over. Here, properties of the curb 200, such as a height and/or a flank angle, can be ascertained. In particular, the position at which the curb 200 was ascertained is ascertained with reference to the trajectory TR to be learned and, for example, stored. When retracing the trajectory TR, it is therefore known at which position of the trajectory TR the curb 200 is arranged, for which reason an erroneous detection of an obstacle can be expected in a corresponding region.

In embodiments (not illustrated), the inclination angle sensor signal NWS does not comprise the inclination angle NW as explained with reference to FIG. 3 but comprises an engine torque and/or a vehicle speed. For example, a necessary engine torque is increased when the vehicle is traveling up an inclined roadway or a step 200 (and, conversely, reduced when traveling down). Furthermore, the vehicle speed can be increased or reduced with a constant engine torque or with a constant engine output when the vehicle is traveling up or down an inclined roadway or a curb 200. Therefore, the inclination angle NW of the vehicle 100 and driving over a curb 200 can likewise be derived from these variables.

FIG. 4 shows a schematic example of detecting an environment sensor signal US indicative of an obstacle, which can cause an erroneous ascertainment of an obstacle. This is, for example, the curb 200 which, as illustrated in FIG. 3, was ascertained during a learning journey on the basis of the inclination angle sensor signal NWS and the position of which was stored. In this example, the vehicle 100 has only ultrasonic sensors 130 (see FIG. 1). When the vehicle 100 approaches the curb 200 in the retracing mode, the curb 200 comes into the detection range of the ultrasonic sensors 130 starting from a specific position along the trajectory TR. Then, as illustrated in FIG. 4, it can occur that an emitted ultrasound signal USS is reflected at the curb 200, so that the ultrasonic sensor 130 receives the reflected ultrasound signal USR. This takes place when the vehicle 100 is still at a certain distance from the curb 200 which, in the present case, is represented by the distance Ad which, for example, relates to the wheel center point of the front wheel. The distance Ad corresponds to a displacement by which erroneous detections of obstacles are expected on the basis of the ascertained specific position of the curb 200 along the trajectory TR. If the curb 200 was driven over at a position x along the trajectory TR, during the retracing, erroneous detections are expected at the position x-Δd, and the retracing is performed in a region around this position x-Δd, for example on the basis of the second rule set R2 (see FIG. 7). The region within which the second rule set R2 is used is, for example, 1.5 meters before the curb 200 to 0.1 meters before the curb 200 (relative to the position of the ultrasonic sensor 130). The extent of the region is chosen in particular depending on the detection range of the respective ultrasonic sensor 130. The distance Δd depends in particular on a geometric distance of a wheel hub from a detection range of a respective environment sensor 130.

In the situation of FIG. 4, the reflected ultrasound signal USR, which represents an environment sensor signal US (see FIG. 6) indicative of an obstacle arranged in the direction of travel of the vehicle 100 at a position of the trajectory, is evaluated according to a second rule set R2 (see FIG. 7). This second rule set R2 is defined in such a way that an erroneous detection rate is reduced, in particular by a threshold value for the detection of the obstacle being increased. Furthermore, the second rule set R2 can provide for the vehicle 100 to pause at the position illustrated and to wait for further ultrasound signals USS, USR, in order to ascertain whether these reliably indicate an obstacle at the position of the curb 200. Furthermore, provision can be made for the vehicle 100 to approach the curb 200 at a reduced speed in order to receive further ultrasound signals USS, USR from other positions, in order to ascertain whether these reliably indicate an obstacle at the position of the curb 200.

FIG. 5 shows six illustrations. Three illustrations (A)-(C) show a vehicle 100 which approaches a curb 200 and drives onto same. Under that, three exemplary diagrams DIAG1-DIAG3 are shown, wherein the upper two diagrams DIAG1, DIAG2 represent examples of a distance-inclination diagram and the lower diagram DIAG3 shows an example of ascertaining a section INT along the trajectory TR within which the second rule set R2 is used and outside of which the first rule set R1 is used.

The first illustration (A) shows the vehicle 100 at a distance Ad in front of the curb 200. In this situation, the curb 200 can be detected erroneously as an obstacle by an environment sensor 130 (see FIG. 1 or 4), as explained in detail previously with reference to FIG. 4. The second illustration (B) shows the vehicle 100 when it has just driven onto the curb 200 with the front wheels. The third illustration (C) shows the vehicle 100 when it has just driven onto the curb 200 with the rear wheels.

The first diagram DIAG1 shows the inclination angle NW(d) of the vehicle 100 as a function of the position d along the trajectory TR. The position along the trajectory TR in this example relates to the front axle of the vehicle 100. When the vehicle 100 is at the position d0, it drives over the curb 200 with the front wheels, as illustrated in the illustration (B), which leads to a sudden rise in the inclination angle NW of the vehicle 100. As long as only the front wheels are at the higher level, the inclination angle NW remains constant at the higher level. When the rear wheels of the vehicle 100 also drive over the curb 200, as illustrated in illustration (C), the inclination angle NW falls to the original level again (this applies to a roadway that is flat in the region of the curb).

The second diagram DIAG2 shows the change in the inclination angle GNW(d) of the vehicle 100 as a function of the position d along the trajectory TR. This is, for example, the gradient of the inclination angle NW of the vehicle 100. Accordingly, at the position d0 there is a (positive) peak, since the inclination angle NW rises abruptly here and, following that, a (negative) peak, since the inclination angle NW falls abruptly here.

The inclination angle sensor signal NWS can thus comprise both the inclination angle NW itself and the change in the inclination angle GNW. The respective represented inclination angle NW can relate to the vehicle 100 or can relate to the roadway.

The third diagram DIAG3 shows three regions which are derived from the diagrams DIAG1, DIAG2 on the basis of the ascertained curb 200. Each region comprises an interval of the trajectory TR. The regions differ from one another in the rule set R1, R2 (see FIG. 7) which is to be applied in the respective region when retracing the trajectory. In particular, the rule set R2 is to be applied in a region INT which is located in an interval at a distance Ad before the position d0, since the vehicle 100 is located in this region INT of the trajectory TR in a position relative to the curb 200 in which erroneous detections are expected, as illustrated in the illustration (A). The width of the region INT in which the second rule set R2 is to be applied, and the location of the region along the trajectory TR in relation to the position of the curb 200, depends in particular on a detection range of the environment sensor 130, which erroneously detects an obstacle. The distance Ad depends in particular on a geometric distance of a wheel hub from a detection range of a respective environment sensor 130. This means that, depending on the sensors used, the region can be arranged differently. In particular if there are different environment sensors 130, a plurality of regions R2 can be provided for a curb 200.

FIG. 6 shows a schematic block diagram of an exemplary embodiment of a parking assistance system 110, for example the parking assistance system of the vehicle 100 of FIG. 1. The parking assistance system 110 is configured to learn a manually traveled trajectory TR in a learning mode (see FIG. 2), and to retrace the learned trajectory TR automatically with the vehicle 100 in a retracing mode. The parking assistance system 110 comprises:
a receiving unit 112, which is configured to receive an inclination angle sensor signal NWS from a sensor unit 120 (see FIG. 1) of the vehicle 100, which signal is indicative of an inclination angle NW (see FIG. 5) of the vehicle or of a roadway and/or a change in the inclination angle GNW (see FIG. 5) of the vehicle or the roadway during the manual travel along the trajectory TR,
an ascertainment unit 114, which is configured to ascertain a curb 200 (see FIGS. 2-4) at a specific position along the trajectory TR depending on the received inclination angle sensor signal NWS, wherein
the receiving unit 112 is also configured to receive an environment sensor signal US from an environment sensor unit 130 (see FIG. 1) of the vehicle 100 during the automatic retracing of the learned trajectory TR, which signal is indicative of an obstacle arranged in the direction of travel of the vehicle 100 at a position of the learned trajectory TR, and
the ascertainment unit 114 is also configured to ascertain the position of the obstacle on the learned trajectory TR depending on the received environment sensor signal US, and wherein
the parking assistance system 110 comprises a control unit 116, which is configured to perform the retracing according to a first rule set R1 (see FIG. 7) or a second rule set R2 (see FIG. 7) depending on a comparison of the ascertained position with the determined position.

FIG. 7 shows a schematic block diagram of an exemplary embodiment of a method for operating a parking assistance system 110, for example the parking assistance system 110 shown in FIG. 6 or the parking assistance system 110 of the vehicle 100 of FIG. 1. The parking assistance system 110 is configured to learn a manually traveled trajectory TR in a learning mode, and to automatically retrace the learned trajectory TR with the vehicle in a retracing mode. In a first step S1, which is to be assigned to the learning mode, during the manual travel along the trajectory TR, an inclination angle sensor signal NWS (see FIG. 6) from a sensor unit 120 (see FIG. 1) of the vehicle 100 is received, which signal is indicative of an inclination angle NW (see FIG. 5) of the vehicle 100 or a roadway and/or a change in the inclination angle GNW (see FIG. 5) of the vehicle 100 or the roadway. In a second step S2, which is to be assigned to the learning mode, a curb 200 (see FIGS. 2-4) at a specific position along the trajectory TR is ascertained depending on the received inclination angle sensor signal NWS. In a third step S3, which is to be assigned to the retracing mode, during the automatic retracing of the learned trajectory, an environment sensor signal US S (see FIG. 6) is received from an environment sensor unit 130 (see FIG. 1) of the vehicle 100. The environment sensor signal US is indicative of an obstacle arranged at a position of the learned trajectory TR in the direction of travel of the vehicle 100. In a fourth step S4, which is to be assigned to the retracing mode, the position of the obstacle on the learned trajectory TR is ascertained depending on the received environment sensor signal US, and in a fifth step S5, which is to be assigned to the retracing mode, the further retracing of the trajectory is performed according to a first rule set R1 or according to a second rule set R2 depending on a comparison of the ascertained position and the specific position.

Although the present invention has been described on the basis of exemplary embodiments, it may be modified in diverse ways.

### LIST OF DESIGNATIONS

100 Vehicle
110 Parking assistance system
112 Receiving unit
114 Ascertainment unit
116 Control unit
120 Inclination angle sensor
130 Environment sensor
150 Environment
200 Step
205 Target position
210 Garage
Δd Distance
d Distance
d0 Position
DIAG1 Diagram
DIAG2 Diagram
DIAG3 Diagram
ESh Horizontal direction
ESv Vertical direction
FSh Horizontal direction
FSv Vertical direction
GNW Gradient of the inclination angle
GNW(d) Course
INT Section
NW Inclination angle
NW(d) Course
NWS Inclination angle sensor signal
R1 Rule set
R2 Rule set
S1 Method step
S2 Method step
S3 Method step
S4 Method step
S5 Method step
TR Trajectory
US Environment sensor signal
USR Ultrasound
USS Ultrasound

1. A method for operating a parking assistance system for a vehicle, wherein the parking assistance system is configured for: learning a manually traveled trajectory in a learning mode; and automatically retracing the learned trajectory with the vehicle in a retracing mode,
wherein the learning mode comprises:
receiving an inclination angle sensor signal from a sensor unit of the vehicle,
wherein the inclination angle signal is indicative of an inclination angle of the vehicle or a roadway and/or a change in the inclination angle of the vehicle or the roadway, during the manual travel along the trajectory,
ascertaining a curb at a specific position along the trajectory depending on the received inclination angle sensor signal, and
wherein the retracing mode comprises:
receiving an environment sensor signal from an environment sensor unit of the vehicle,
wherein the environmental sensor signal is indicative of an obstacle arranged in the direction of travel of the vehicle at a position of the learned trajectory during the automatic retracing of the learned trajectory,
ascertaining the position of the obstacle on the learned trajectory depending on the received environment sensor signal, and
performing the retracing according to a first rule set or according to a second rule set depending on a comparison of the ascertained position and the position determined in the learning mode.

2. The method as claimed in claim 1, further comprising:
performing the retracing according to the first rule set if the ascertained position differs from the position determined in the learning mode, and
performing the retracing according to the second rule set if the ascertained position coincides with the position determined in the learning mode.

3. The method as claimed in claim 1,
wherein the second rule set comprises a threshold value, adjusted with respect to the first rule set, for ascertaining an obstacle depending on the environment sensor signal.

4. The method as claimed in claim 1,
wherein the second rule set comprises suppressing an output of a signal indicative of the obstacle.

5. The method as claimed in claim 1,
wherein the second rule set comprises outputting a false-positive signal which is indicative of the fact that the obstacle is an obstacle that can be driven over.

6. The method as claimed in claim 1, further comprising:
ascertaining a distance-inclination diagram depending on the inclination angle sensor signal received during the manual travel along the trajectory, and
ascertaining a number of sections along the trajectory TR within which the automatic retracing is carried out according to the second rule set, depending on the ascertained distance-inclination diagram.

7. The method as claimed in claim 1, further comprising:
ascertaining a height and/or a flank angle of the curb depending on the received inclination angle sensor signal, and
adjusting at least one parameter of the second rule set depending on the ascertained height and/or the ascertained flank angle.

8. The method as claimed in claim 1,
wherein the environment sensor signal comprises a sensor signal from an ultrasonic sensor, a laser scanner and/or a lidar.

9. A non-transient computer readable medium, comprising commands which, when executed by a parking assistance system of a vehicle, cause the parking assistance system to perform the method as claimed in claim 1.

10. A parking assistance system for a vehicle,
wherein the parking assistance system is configured to learn a manually traveled trajectory in a learning mode, and to automatically retrace the learned trajectory with the vehicle in a retracing mode,
the parking system comprising:
a receiving unit, which is configured to receive an inclination angle sensor signal from a sensor unit of the vehicle,
wherein the inclination angle signal is indicative of an inclination angle of the vehicle or of a roadway and/or a change in the inclination angle of the vehicle or the roadway during the manual travel along the trajectory, and
an ascertainment unit, which is configured to ascertain a curb at a specific position along the trajectory depending on the received inclination angle sensor signal,
wherein the receiving unit is also configured to receive an environment sensor signal from an environment sensor unit of the vehicle during the automatic retracing of the learned trajectory,
wherein the environmental sensor signal is indicative of an obstacle arranged in the direction of travel of the vehicle at a position of the learned trajectory, and
wherein the ascertainment unit is also configured to ascertain the position of the obstacle on the learned trajectory depending on the received environment sensor signal, and
wherein the parking assistance system comprises a control unit, which is configured to perform the retracing according to a first rule set or a second rule set depending on a comparison of the ascertained position with the position determined in the learning mode.

11. A vehicle comprising:
at least one sensor unit for detecting and outputting an inclination angle sensor signal indicative of an inclination angle of the vehicle or a roadway and/or of a change in the inclination angle of the vehicle or the roadway,
an environment sensor unit for detecting and outputting an environment sensor signal indicative of an obstacle arranged in the direction of travel of the vehicle, and
a parking assistance system as claimed in claim 10.
